(19) United States
(12) Patent Application Publication
(10) Pub. No.: US 2006/0019704 A1
(43) Pub. Date: Jan. 26, 2006

(54) Integrating wireless telephone with external call processor

(76) Inventors: Mike Kwon, San Diego, CA (US); Lixin Cheng, San Diego, CA (US); Simon S. Yi, San Diego, CA (US); Kazuhiko Shirai, San Diego, CA (US)

Correspondence Address: FROMMER LAWRENCE & HAUG, 745 FIFTH AVENUE- 10TH FL., NEW YORK, NY, 10151, US

(21) Appl. No.: 11/123,450

(22) Filed: May 6, 2005

Related U.S. Application Data
(60) Provisional application No. 60/569,916, filed on May 10, 2004.

(51) Int. Cl. H04M 1/00

(52) U.S. Cl. 455/556.1

(57) ABSTRACT

An integrated call processing system, comprising: a wireless telephone including a keypad, a speaker, and a microphone to enable entry of call information and to enable phone transaction through one of a plurality of telephone networks; and a software telephone processor configured to receive and process the call information, wherein the processed call information is used to open phone transaction through a telephone network that incurs lowest price.

### CROSS-REFERENCE TO RELATED APPLICATIONS

This application claims the benefit of priority of co-pending U.S. Provisional Patent Application Ser. No. 60/569,916 entitled “Wireless Telephone with External Call Processing Interfaces”, filed May 10, 2004. Benefit of priority of the filing date of May 10, 2004 is hereby claimed, and the disclosure of the Provisional Patent Application is hereby incorporated by reference.

### BACKGROUND

Telephone services can be provided using an increasingly variety of methods, such as by using a traditional wireline telephone over the public switched telephone network (PSTN), by using a wireless telephone over the cellular network, or by using a Voice over Internet Protocol (VoIP) phone over the Internet. Some of the newer services may utilize a data terminal, such as a personal computer (PC) or personal data assistant (PDA), having a software telephone application installed in the terminal. However, to provide the telephone service, the data terminal requires peripheral accessories, such as keypad, speaker, microphone, and/or display, for inputting and outputting audio and/or data signals. Further, changing from one telephone service method to another telephone service method involves a change of phones including porting/copying of personal information, such as personal phonebook data, from one phone to another phone.

### SUMMARY

The present invention provides methods, systems, and computer programs for integrating wireless telephone with an external call processor.

In one implementation, an integrated call processing system is disclosed. The system includes: a wireless telephone including a keypad, a speaker, and a microphone to enable entry of call information and to enable phone transaction through one of a plurality of telephone networks; and a software telephone processor configured to receive and process the call information, wherein the processed call information is used to open phone transaction through a telephone network that incurs lowest price.

In another implementation, an integrated call processing method is disclosed. The method includes: providing a wireless telephone including a keypad, a speaker, and a microphone to enable entry of call information and to enable phone transaction through one of a plurality of telephone networks; and receiving and processing the call information using a software telephone processor, wherein the processed call information is used to open phone transaction through a telephone network that incurs lowest price.

### BRIEF DESCRIPTION OF THE DRAWINGS

FIG. 1 shows one example of an integrated call processing system integrating a wireless telephone and a data terminal through an interface.

FIG. 2 shows a detailed block diagram of another example of an integrated call processing system including a wireless telephone, a hardware interface, and a data terminal.

FIG. 3 shows a detailed block diagram of another example of an integrated call processing system.

### DETAILED DESCRIPTION

The integration of wireless telephone with an external call processor involves configuring the wireless telephone and a data terminal, such as a personal computer (PC) or personal data assistant (PDA), having a software telephone application installed in the terminal. In one implementation, the wireless telephone is a cellular telephone providing telephone service over the cellular network. In another implementation, the wireless telephone is a telephone providing telephone service over the public switched telephone network (PSTN).

The configuration of the wireless telephone and a data terminal includes adding an interface driver to each of the wireless telephone and the data terminal so that audio and/or data signals can be exchanged between the wireless telephone and the data terminal. Thus, the integrated system enables the data terminal to use the wireless telephone as a peripheral accessory device providing input and output functions through the keypad, speaker, microphone, and/or display of the wireless telephone. The integrated system also enables the wireless telephone to provide a telephone service over the cellular network or over the Internet using the software telephone application (e.g., VoIP) installed in the data terminal. Further, the integrated system obviates the need to port or copy the personal information stored in the wireless telephone into the software telephone application of the data terminal since dialing information can be extracted from the personal information stored in the wireless telephone and transmitted to the data terminal as any other manually entered dialing information.

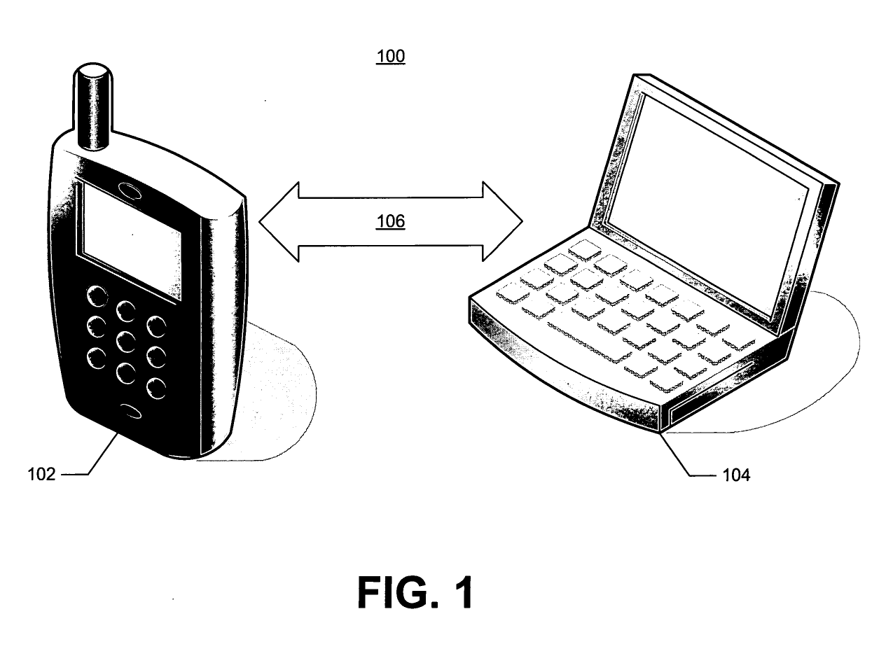

FIG. 1 shows one example of an integrated call processing system 100 integrating a wireless telephone 102 and a data terminal 104 through an interface 106. In the illustrated example of FIG. 1, the wireless telephone 102 can be configured as a cellular telephone providing telephone service over the cellular network or as a cordless telephone providing telephone service over the PSTN. The data terminal 104 can be configured as a PC, PDA, VoIP terminal, or VoIP telephone. In one implementation, a software telephone application is installed in the data terminal 104.

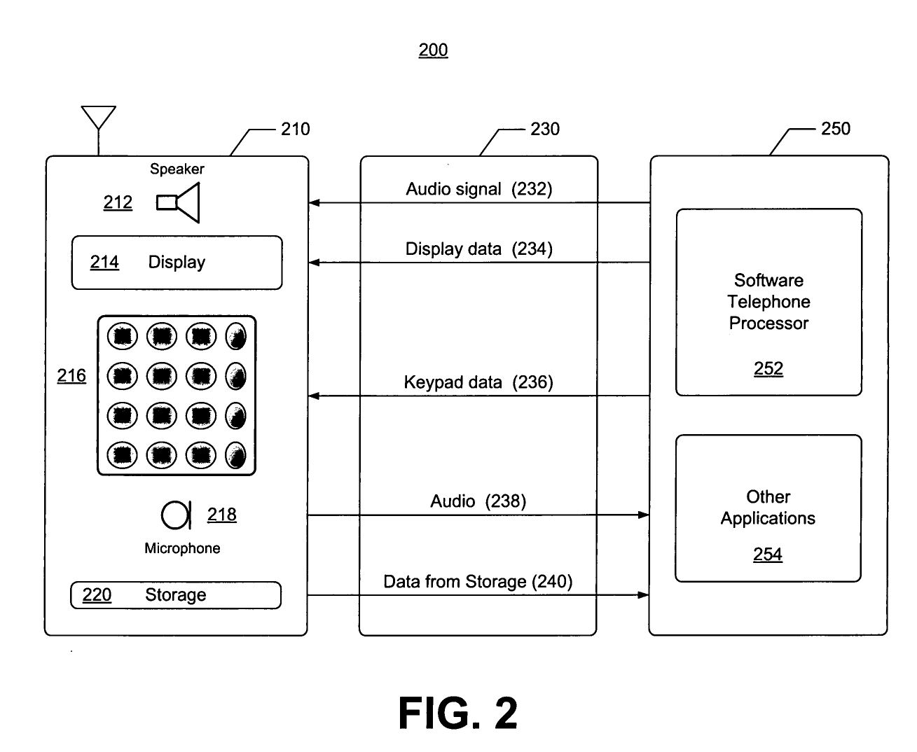

FIG. 2 shows a detailed block diagram of another example of an integrated call processing system 200 including a wireless telephone 210, a hardware interface 230, and a data terminal 250. In the illustrated example of FIG. 2, the wireless telephone 210 includes a speaker or earpiece 212, display 214, keypad 216, microphone 218, and/or storage 220. The display 214 typically shows the dialing information such as a calling telephone number. The storage 220 typically stores personal information of the user such as a phonebook.

The hardware interface 230 includes I/O interface line 232 for an audio signal to the speaker 212, line 234 for a signal to the display 214, line 236 for a signal from the keypad 216, line 238 for an audio signal from the microphone 218, and line 240 for data from the storage 220. The keypad 216 is the input device for numbers, alphabets, special characters and specific functions. The display 214 is the output device showing menus, status, and character/picture information. The audio signal from the microphone 218 is an electrical signal from the wireless telephone 210, which can either be analog or digital depending on the availability of the analog signal line in the hardware interface 230. The audio signal to the speaker 212 is an electrical signal to the wireless telephone 210, which can either be analog or digital depending on the availability of the analog signal line in the hardware interface 230. The storage 220 is a data file storing personal information such as an electronic phonebook.

In some implementations, the hardware interface 230 is configured as a Universal Serial Bus (USB) interface, Bluetooth interface, wireless local area network (LAN), infrared interface, or serial interface with or without audio signal lines. The data terminal 250 includes a software telephone application, such as a VoIP software application, running on a software telephone processor 252 and other applications 254.

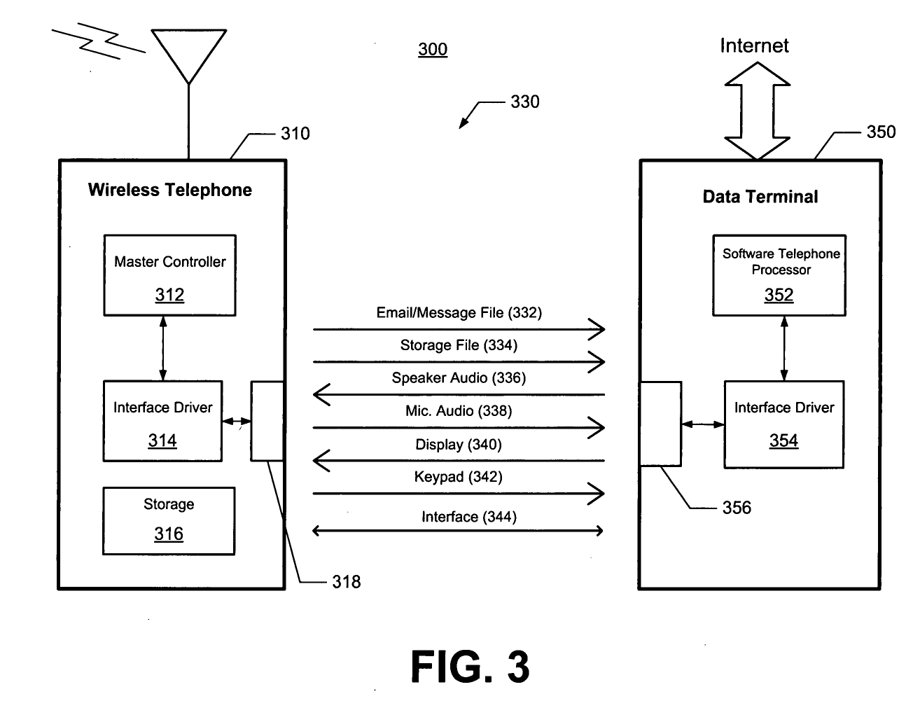

FIG. 3 shows a detailed block diagram of another example of an integrated call processing system 300. The integrated call processing system 300 of FIG. 3 includes a wireless telephone 310, an interface 330, and a data terminal 350. The wireless telephone 310 includes a master controller 312, an interface driver 314, storage 316, and a hardware interface 318. The interface 330 includes an email/message file line 332, a storage file line 334, a speaker audio line 336, a microphone audio line 338, a display data line 340, a keypad data line 342, and other physical interface data line 344. The data terminal 350 includes a software telephone processor 352, an interface driver 354, and a hardware interface 356. The email/message file is a data file of email or message contents, such as character short message, audio clip, video clip that is stored in the wireless telephone and is used by the software telephone processor 352 when a user sends email, audio, or video messages.

The master controller 312 includes a mode in which user operations to make/receive phone calls is input on the keypad 216 of the wireless telephone 210/310 and is routed through the hardware interfaces 318, 358 to cause the software telephone processor 352 in the data terminal 350 to initiate phone calls. The master controller 312 is also configured to automatically detect the existence of the software telephone processor 352 in the data terminal 350, to check the status/functionality of the readiness of the software telephone processor 352 (e.g., whether the processor 352 is connected to the Internet so that the VoIP call can be made), and to allow the user to select the call route through the Internet using the software telephone processor 352 or through other telephone network such as a cellular network. The software telephone processor 352 can use call routes other than the Internet. Preferably, the software telephone processor 352 uses the call route that incurs lowest price. The selection of the call route can be pre-programmed.

The master controller 312 is further configured to process the user operation to determine whether the call information should be received from the keypad, the phonebook, or hyperlinked texts in an email text or browser content. Once the call information is determined, the dialing sequence of the call information is translated to equivalent manual keypad dialing sequence. This translated sequence is transmitted to the software telephone processor 352 through the interface line 344.

The interface drivers 314, 354 enable the wireless telephone 310 to operate substantially similar to a generic audio input/output, keypad, and storage device for the software telephone processor 352 of the data terminal 350.

The various implementations of the invention are realized in electronic hardware, computer software, or combinations of these technologies. Some implementations include one or more computer programs executed by a programmable processor or computer. For example, referring to FIG. 3, in one implementation, the interface drivers include computer programs executed by processors. In general, each computer includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

The computer programs include executable code that is usually stored in a persistent storage medium and then copied into memory at run-time. The processor executes the code by retrieving program instructions from memory in a prescribed order. When executing the program code, the computer receives data from the input and/or storage devices, performs operations on the data, and then delivers the resulting data to the output and/or storage devices.

Various illustrative implementations of the present invention have been described. However, one of ordinary skill in the art will see that additional implementations are also possible and within the scope of the present invention. For example, while the above description focuses on integration of the wireless telephone with a data terminal, other implementations can involve integration of wireless telephone with other external call processors such as an instant messaging system or video conferencing system.

Accordingly, the present invention is not limited to only those implementations described above.

What is claimed is:

1. An integrated call processing system, comprising:
a wireless telephone including a keypad, a speaker, and a microphone to enable entry of call information and to enable phone transaction through one of a plurality of telephone networks; and
a software telephone processor configured to receive and process the call information,
wherein the processed call information is used to open phone transaction through a telephone network that incurs lowest price.

2. The system of claim 1, wherein the call information is received from the keypad.

3. The system of claim 1, wherein the wireless telephone further includes a master controller configured to translate the call information into a dialing sequence.

4. The system of claim 3, wherein the wireless telephone further includes an electronic phonebook.

5. The system of claim 4, wherein the master controller receives the call information from the phonebook.

6. The system of claim 3, wherein the wireless telephone further includes an email/message file.

7. The system of claim 6, wherein the master controller receives the call information from hyperlinked texts in the email/message file.

8. The system of claim 1, wherein the software telephone processor resides in a data terminal.

9. The system of claim 8, wherein the data terminal includes a personal computer, a personal data assistant, VoIP terminal, and VoIP telephone.

10. An integrated call processing method, comprising:
providing a wireless telephone including a keypad, a speaker, and a microphone to enable entry of call information and to enable phone transaction through one of a plurality of telephone networks; and
receiving and processing the call information using a software telephone processor,
wherein the processed call information is used to open phone transaction through a telephone network that incurs lowest price.

11. The method of claim 10, wherein said receiving and processing the call information includes receiving the call information from the keypad.

12. The method of claim 10, further comprising
translating the call information into a dialing sequence.

13. The method of claim 12, wherein the wireless telephone further includes an electronic phonebook.

14. The method of claim 13, wherein said receiving and processing the call information includes receiving the call information from the phonebook.

15. The method of claim 12, wherein the wireless telephone further includes an email/message file.

16. The method of claim 15, wherein said receiving and processing the call information includes receiving the call information from hyperlinked texts in the email/message file.
